(19) United States
(12) Patent Application Publication
(10) Pub. No.: US 2023/0034569 A1
(43) Pub. Date: Feb. 2, 2023

(54) COMPUTING DEVICE WITH SEPARABLE DISPLAY AND KEYBOARD MODULE

(71) Applicant: Hewlett-Packard Development Company, L.P., Spring, TX (US)

(72) Inventors: Ying-Ting Chen, Taipei City (TW); Yao-Te Chiu, Taipei City (TW); Yi-Leng Kuo, Taipei City (TW)

(73) Assignee: Hewlett-Packard Development Company, L.P., Spring, TX (US)

(21) Appl. No.: 17/789,597

(22) PCT Filed: Jan. 20, 2020
(86) PCT No.: PCT/US2020/014274

§ 371 Date: Jun. 28, 2022

(51) Int. Cl. G06F 3/14; G06F 3/023; G06F 3/02; H04R 3/00; H04R 1/02; H04R 1/08

(52) U.S. Cl. CPC G06F 3/1454; G06F 3/0231; G06F 3/021; H04R 3/00; H04R 1/028; H04R 1/08; H04R 2420/07; H04R 2499/15

(57) ABSTRACT

An example keyboard module for a computing device may be separable and wirelessly communicable with a display module. In some examples, the keyboard module may include a wireless transceiver to receive a first audio signal from the display module and to transmit a second audio signal to the display module. The first audio signal may be output by a speaker on the keyboard module. The second audio signal may be captured by a microphone on the keyboard module. In some examples, the keyboard module may include a wireless display receiver to receive a display image from the display module. In some examples, the keyboard module may include a display output port to output the received display image for an external display.

### BACKGROUND

Computing devices are used to perform a variety of tasks, including work activities, banking, research, entertainment and communication. Networking technology may enable computing devices to communicate. For example, a computing device may send and/or receive audio data and/or video data via a network. In this way, information may be shared and/or communicated between computers.

### BRIEF DESCRIPTION OF THE DRAWINGS

Various examples will be described below by referring to the following figures.

FIG. 1 is a block diagram illustrating an example of a computing device with a separable display module and keyboard module;

FIG. 2 is a block diagram illustrating another example of a computing device with a separable display module and keyboard module;

FIG. 3 is a flow diagram illustrating an example of a method by a keyboard module;

FIG. 4 is a flow diagram illustrating another example of a method by a keyboard module; and

FIGS. 5A and 5B illustrate examples of a computing device in a laptop mode and a conference mode.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations in accordance with the description; however, the description is not limited to the examples and/or implementations provided in the drawings.

### DETAILED DESCRIPTION

Examples of a computing device with separable display and keyboard module are described herein. In some examples, the described computing device may be used for enhancing an audio and/or video conference experience by using the computing device in a conference mode.

In some scenarios, the computing device may be used for an audio or video conference. In these scenarios, the computing device may be located in a conference room. Sometimes when a user joins a meeting through a computing device (e.g., laptop), the audio conference experience is not optimal on the other side (e.g., the party listening to the audio transmitted by the computing device). This may be due to the location of a user in relation to the microphone of the computing device. For example, when an attendee's voice comes from the corner of the conference room or from behind the computing device, the microphone may be too far away or too obscured to properly capture a high-quality audio signal of the attendee.

Additionally, the placement of the computing device in the conference room may limit its ability to connect to an external display (e.g., projector, monitor, etc.). For example, a presenter using the computing device may be located far away from a connection to an external monitor. In this case, the cords or other interface mechanisms of the external monitor may not reach the computing device.

The audio and/or video conference experience may be enhanced by the computing device described herein. The computing device may include a separable display module and keyboard module. For example, the computing device may be a 2-in-1 laptop where the keyboard module separates from the main display module.

The computing device may enhance the audio and/or video conference experience without a separate conference room device. For example, the display module and the keyboard module may be detachable (i.e., separable) from each other. The keyboard module may be equipped with a speaker, microphone and battery.

In some examples, the keyboard module may use a wireless link (e.g., Bluetooth link) to the display module to communicate audio and other data in conference settings. In some examples, the keyboard module can provide a high quality speaker and microphone to enhance the audio conference experience. For example, the keyboard module may include a wireless transceiver (e.g., a Bluetooth transceiver) for wirelessly receiving and transmitting audio signals and other data (e.g., keyboard input data) to/from the display module.

The keyboard module may further use a display link to bridge the display module to an external monitor. For example, the keyboard module may include a wireless display receiver (e.g., Miracast receiver) for receiving display images wirelessly from the display module. The keyboard module may also include a display output port (e.g., HDMI, VGA, etc.) for rendering the received display images onto an external display (e.g., a projector or large-size monitor).

In some examples, the display module may be equipped with a wireless display transmitter (e.g. Miracast transmitter) for wirelessly transmitting display images. The display module may also include a wireless transceiver (e.g., a Bluetooth transceiver) for transmitting and receiving an audio signal and other data (e.g., keyboard input data) to/from the keyboard module. Hence, the stand-alone wireless keyboard module will enhance the conference experience.

The keyboard module may also extend the battery of the display module by acting as a power bank. For example, the battery can charge the display module when connected to the keyboard module to extend use time of the display module. This may reduce the weight of the display module by reducing the battery size of the display module. To compensate for the decreased battery life of the display module, the keyboard module may charge the display module when the modules are connected.

As seen by these examples, the keyboard module may provide more than just a keyboard feature. Instead, the keyboard module may also provide a high-quality microphone and speaker. The keyboard module may also provide a display output port to connect an external display to share the screen of the display module with others.

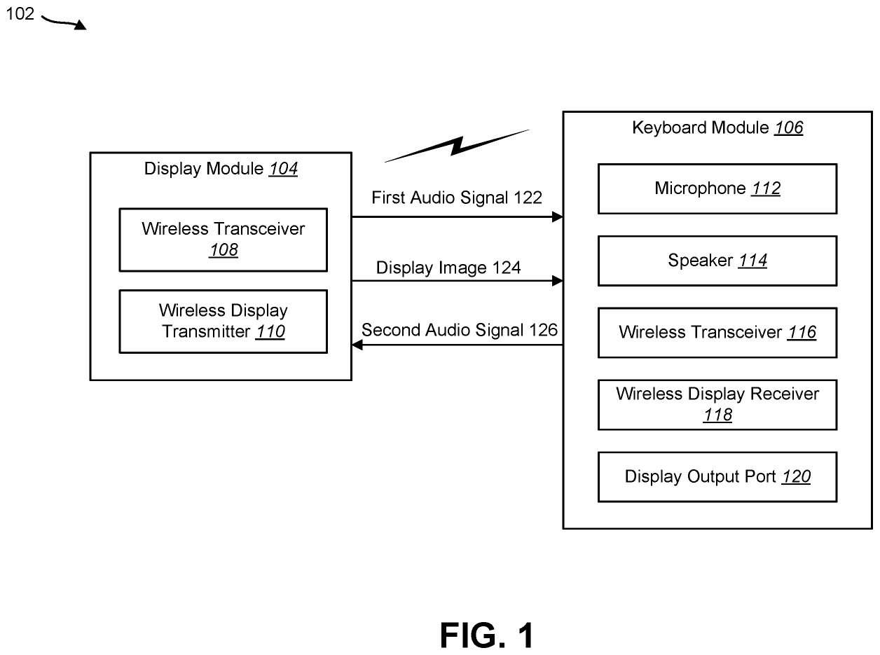

FIG. 1 is a block diagram illustrating an example of a computing device 102 with a separable display module 104 and keyboard module 106. Examples of computing devices 102 may include laptop computers, 2-in-1 laptop computers, desktop computers, tablet devices, smart phones, cellular phones, game consoles, server devices, and/or smart appliances, etc. In other examples, the computing device 102 may be a distributed set of devices. For example, the computing device 102 may include multiple discrete devices organized in a system to implement the processes described herein. As used herein, the term “module” refers to a physically discrete component of the computing device 102.

In some examples, the display module 104 may include a processor. The processor may be any of a central processing unit (CPU), a microcontroller unit (MCU), a semiconductor-based microprocessor, graphics processing unit (GPU), field-programmable gate array (FPGA), an application-specific integrated circuit (ASIC), and/or other hardware devices suitable for retrieval and execution of instructions stored in the memory. The processor may fetch, decode, and execute instructions, stored on the memory and/or data storage, to implement printing device functionality based on consumption and payment.

The memory may include read only memory (ROM) and/or random access memory (RAM). The memory and the data storage may also be referred to as a machine-readable storage medium. A machine-readable storage medium may be any electronic, magnetic, optical, or other physical storage device that contains or stores executable instructions. Thus, the machine-readable storage medium may be, for example, RAM, EEPROM, a storage device, an optical disc, and the like. In some examples, the machine-readable storage medium may be a non-transitory machine-readable storage medium, where the term “non-transitory” does not encompass transitory propagating signals. The machine-readable storage medium may be encoded with instructions that are executable by the processor.

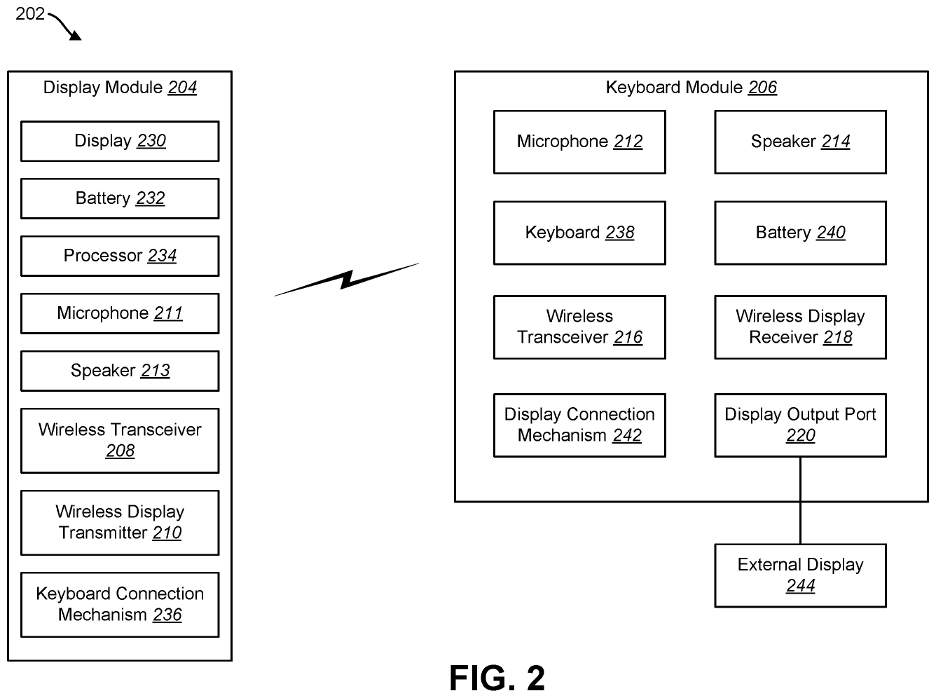

In some examples, the display module 104 may include a microphone to capture an audio signal. In some examples, the display module 104 may include a speaker to output an audio signal. An example of this approach is described in FIG. 2.

The keyboard module 106 may provide a user interface to the display module 104. For example, the keyboard module 106 may include a keyboard, keypad, or other input device to receive user input. The keyboard module 106 may communicate the user input to the display module 104.

In some examples, the display module 104 and the keyboard module 106 may be separable and wirelessly communicable. For example, in one mode (referred to herein as a laptop mode), the display module 104 and the keyboard module 106 may be connected. For instance, the display module 104 and the keyboard module 106 may include connection mechanisms to connect to each other. In some examples, the connection mechanisms may facilitate direct communication between the display module 104 and the keyboard module 106.

In another mode (referred to herein as conference mode), the keyboard module 106 may be physically separated from the display module. For example, the connection mechanisms of the keyboard module 106 and the display module 104 may allow the keyboard module 106 to separate from the display module 104.

To facilitate communication when in conference mode, in some examples, the display module 104 and the keyboard module 106 may each include their own battery. Therefore, when separated, the display module 104 may function on a power source independent of the keyboard module 106. In other examples, the display module 104 and/or the keyboard module 106 may be powered by a line (e.g., wire) connection to a power outlet.

In some examples, the keyboard module 106 may include a microphone 112 to capture an audio signal. For example, the microphone 112 may be located on the keyboard module 106 in a manner to facilitate capturing the speaking voice of a user.

In some examples, the keyboard module 106 may include a speaker 114 to output an audio signal. For example, the speaker 114 may be powered by a battery or other power source of the keyboard module 106. The speaker 114 may output sound corresponding to an audio signal (e.g., first audio signal 122) provided by the display module 104 or other audio source. In some examples, the speaker 114 may be a Bluetooth speaker.

The display module 104 may include a wireless transceiver 108. In some examples, the wireless transceiver 108 may be a Bluetooth transceiver. The keyboard module 106 may also include a wireless transceiver 116 (e.g., a Bluetooth transceiver). As used herein, a “transceiver” includes a transmitter to transmit a signal and a receiver to receive a signal. A transceiver may also include an antenna to send and receive signals.

In some examples, the wireless transceiver 116 of the keyboard module 106 may be incorporated as part of the speaker 114. For example, the speaker 114 may be a Bluetooth speaker that includes its own wireless transceiver 116. In this case, the speaker 114 may be a standalone Bluetooth audio speaker, which provides flexibility for audio sources to a user. In other examples, the wireless transceiver 116 of the keyboard module 106 may be separate from the speaker 114.

The wireless transceiver 108 of the display module 104 may establish a wireless link (e.g., a Bluetooth link) with the wireless transceiver 116 of the keyboard module 106. For example, the wireless transceiver 116 of the keyboard module 106 and the wireless transceiver 108 of the display module 104 may communicate using Bluetooth. It should be noted that other protocols and/or technologies may be used to facilitate wireless communication between the display module 104 and the keyboard module 106.

The wireless transceiver 108 of the display module 104 may transmit a first audio signal 122. For example, the first audio signal 122 may be an audio stream received at the display module 104. In this example, the first audio signal 122 may be a received audio stream for a conference call received at the display module 104. In other examples, the first audio signal 122 may be other types of audio data stored or received at the display module 104. For example, the first audio signal 122 may be a music file or audio portion of a video file or video stream. In yet other examples, the first audio signal 122 may be an audio signal captured by a microphone on the display module 104.

The wireless transceiver 116 of the keyboard module 106 may receive the first audio signal 122 from the display module 104. For example, the first audio signal 122 may be received and processed at the keyboard module 106. The first audio signal 122 may be output (e.g., played) by the speaker 114.

In some examples, the wireless transceiver 116 of the keyboard module 106 may transmit a second audio signal 126 to the display module 104. For example, the second audio signal 126 may be captured by the microphone 112 of the keyboard module 106. The wireless transceiver 108 of the display module 104 may receive the second audio signal 126.

Upon receiving the second audio signal 126, the display module 104 may play the second audio signal 126 or forward the second audio signal 126 to another computing device. For example, the second audio signal 126 may be the audio originating from the computing device 102 for a conference call with another device.

In some examples, the wireless transceiver 116 of the keyboard module 106 may also wirelessly communicate keyboard input to the display module 104. For example, as a user types on the keyboard of the keyboard module 106, the keyboard input may be transmitted to the display module 104 for processing.

To enhance a video experience, the display module 104 may include a wireless display transmitter 110 and the keyboard module 106 may include a wireless display receiver 118. In some examples, the wireless display transmitter 110 of the display module 104 and the wireless display receiver 118 of the keyboard module 106 may communicate using a wireless networking standard. For example, the wireless display transmitter 110 of the display module 104 and the wireless display receiver 118 of the keyboard module 106 may communicate using Miracast or other Wi-Fi standard. It should be noted that other wireless communication protocols and/or technologies may be used to communicate video signals between the display module 104 and the keyboard module 106.

The wireless display transmitter 110 of the display module 104 may transmit a display image 124 to the keyboard module 106. For example, the wireless display receiver 118 of the keyboard module 106 may receive the display image 124 from the wireless display transmitter 110 of the display module 104. In some examples, the display image 124 may be a mirror of the screen of the display module 104. For example, the wireless display transmitter 110 may transmit an image of what is currently being displayed on the screen of the display module 104. In other examples, the display image 124 may be video data that is not currently displayed on the screen of the display module 104.

The keyboard module 106 may include a display output port 120 to output the received display image 124 for an external display. For example, the display output port 120 may be a Universal Serial Bus (USB) interface, DisplayPort interface, High-Definition Multimedia Interface (HDMI) or Video Graphics Array (VGA) interface. It should be noted that other technologies may be used to implement the display output port 120. A plug of the external monitor may be inserted into the display output port 120 to receive the display image 124. Therefore, the display image 124 (e.g., mirrored screen or other video data) provided by the display module 104 may be displayed on the external display. Because the keyboard module 106 is separable from the display module 104, the keyboard module 106 may connect to an external display that is physically located at a distance that would be unreachable to the display module 104.

In some examples, the keyboard module 106 may include additional ports (not shown) to enable external devices to communication with the display module 104. For example, the keyboard module 106 may include USB ports, which may be used to attach USB devices (e.g., a USB mouse). The external devices may wirelessly communicate with the display module 104 via the keyboard module 106.

The computing device 102 described herein may provide a high-quality audio conference experience through the wireless audio speaker (e.g., Bluetooth speaker). The system screen of the display module 104 may be presented through the keyboard module 106. The battery of the keyboard module 106 may extend system use and/or work time. Because no extra conference room device(s) is used for a group meeting, meeting setup is simplified. Furthermore, the weight of the display module 104 may be reduced due to a smaller battery on the display module 104, but the use time of the display module 104 may be maintained when connected to the battery of the keyboard module 106.

FIG. 2 is a block diagram illustrating another example of a computing device 202 with a separable display module 204 and keyboard module 206. The computing device 202 of FIG. 2 may be implemented in accordance with the computing device 102 of FIG. 1. In this example, additional components and configurations are described.

The computing device 202 may include a display module 204 and a keyboard module 206. The display module 204 may include a display 230 (e.g., a monitor or touchscreen display). The display module 204 may also include a battery 232 to provide power to the display module 204.

The display module 204 may include a processor 234. The processor 234 may be a CPU, an MCU, a semiconductor-based microprocessor, a GPU, an FPGA, an ASIC, and/or other hardware devices suitable for retrieval and execution of instructions stored in memory. In some examples, the processor 234 may execute an operating system (OS). Therefore, the display module 204 may be the main system component of the computing device 202.

In some examples, the display module 204 may include a microphone to capture an audio signal. For example, the microphone 211 may be located on the display module 204 in a manner to facilitate capturing the speaking voice of a user. In some examples, the microphone 211 may capture the first audio signal 122 transmitted from the display module 204 to the keyboard module 206. It should be noted that in other examples, the display module 204 may not include a microphone 211.

In some examples, the display module 204 may include a speaker 213 to output an audio signal. For example, the speaker 212 may be powered by the battery 232 or other power source of the display module 204.

The display module 204 may include a wireless transceiver 208 to wirelessly communicate audio signals to the keyboard module 206. The display module 204 may also include a wireless display transmitter 210 to transmit a display image to the keyboard module 206.

In some examples, the microphone 211 of the display module 204 and the microphone 212 of the keyboard module 206 may complement each other to expand the audio capturing capability of the computing device 202. For example, when separated from each other, the microphone 211 of the display module 204 may capture one audio signal and the microphone 212 of the keyboard module 206 may capture another audio signal. This may facilitate capturing multiple voices located in different locations.

In some examples, the speaker 213 of the display module 204 and the speaker 214 of the keyboard module 206 may complement each other to expand the audio output capability of the computing device 202. For example, when separated from each other, both the speaker 213 of the display module 204 and the speaker 214 of the keyboard module 206 may output a received audio signal (e.g., a remote audio signal in a conference call). This may facilitate audio playback for multiple listeners located in different locations.

In some examples, the display module 204 may include a keyboard connection mechanism 236. The keyboard connection mechanism 236 may interface with a display connection mechanism 242 of the keyboard module 206 to provide a physical connection between the display module 204 and the keyboard module 206. The keyboard connection mechanism 236 and the display connection mechanism 242 may also permit the display module 204 to separate from the keyboard module 206. When connected, the keyboard connection mechanism 236 and the display connection mechanism 242 may interface to allow the display module 204 and the keyboard module 206 to exchange data. Furthermore, when connected, the battery 240 (or line power source) of the keyboard module 206 may charge the battery 232 of the display module 204 and vice versa.

The keyboard module 206 may include a keyboard 238. In some examples, the keyboard 238 may be a laptop-size keyboard with a number of keys to provide a user interface to the display module 204. In some examples, the keyboard module 206 may include a trackpad, touchpad or other pointing input device (not shown).

In some examples, the keyboard module 206 may include a microphone 212 to capture an audio signal (e.g., a user's voice). The keyboard module 206 may also include a speaker 214 to output an audio signal received from the display module 204 or other source. In some examples, the speaker 214 may be powered by a battery 240 or other power source of the keyboard module 206. In some examples, the speaker 214 may be a Bluetooth speaker. For example, the speaker 214 may communicate with the display module 204 over a Bluetooth link.

In some examples, the keyboard module 206 may also include a wireless transceiver 216 to communicate (e.g., send and/or receive) audio signals with the display module 204. In some examples, the wireless transceiver 216 of the keyboard module 206 may also wirelessly communicate input to the keyboard 238 to the display module 204.

The keyboard module 206 may also include a wireless display receiver 218 to receive a display image from the display module 204. In some examples, the display image may be a mirror of the screen of the display module 204. For example, the image displayed on the display 230 of the display module 204 may be mirrored in the display image transmitted to the keyboard module 206.

The keyboard module 206 may include a display output port 220 to output the received display image 124 for an external display 244. For example, the display output port 220 may be a USB interface, DisplayPort interface, HDMI interface, VGA interface or other video interface. In some examples, the external display 244 may be a projector or monitor.

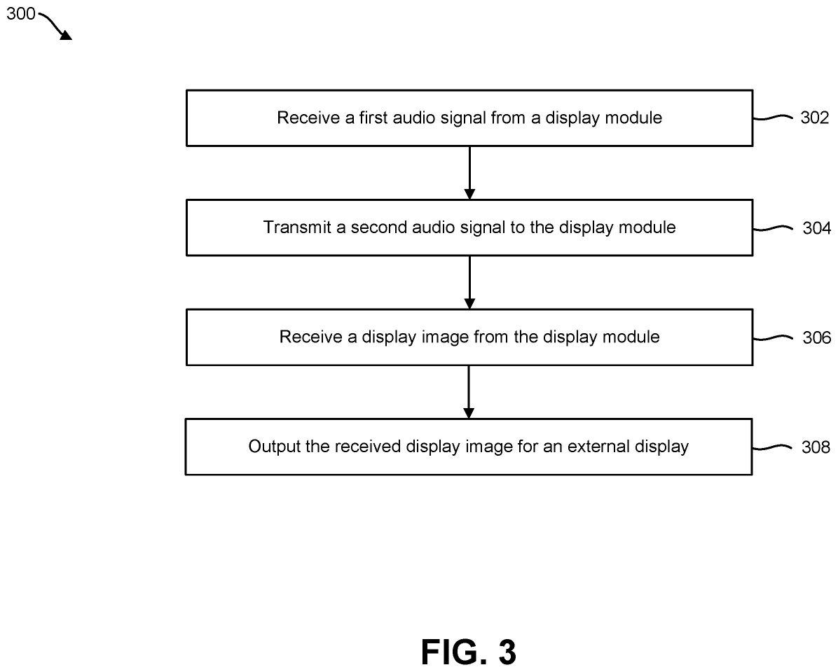

FIG. 3 is a flow diagram illustrating an example of a method 300 by a keyboard module 106. The keyboard module 106 may be separable and wirelessly communicable with a display module 104.

The keyboard module 106 may receive 302 a first audio signal 122 from the display module 104. For example, the keyboard module 106 may be separated from the display module 104. The keyboard module 106 may use a wireless transceiver 116 to establish a wireless link with the display module 104. In an example, the wireless transceiver 116 of the keyboard module 106 and a wireless transceiver 108 of the display module 104 may communicate using Bluetooth. The first audio signal 122 may be output by a speaker 114 on the keyboard module 106.

The keyboard module 106 may transmit 304 a second audio signal 126 to the display module 104. For example, the second audio signal 126 may be captured by a microphone 112 on the keyboard module 106. The keyboard module 106 may transmit 304 the second audio signal 126 using the wireless transceiver 108.

The keyboard module 106 may receive 306 a display image 124 from the display module 104. For example, the keyboard module 106 may include a wireless display receiver 118. The display module 104 may transmit the display image 124 to the wireless display receiver 118 of the keyboard module 106. In some examples, the wireless display transmitter 110 of the display module 104 may communicate the display image 124 to the wireless display receiver 118 of the keyboard module 106 using Miracast.

The keyboard module 106 may output 308 the received display image 124 for an external display 244. For example, the keyboard module 106 may include a display output port 120 to interface with the external display 244. The keyboard module 106 may output 308 the received display image 124 to the display output port 120. In some examples, the keyboard module 106 may mirror a screen of the display module 104 to the external display 244 using the display output port 120.

In some examples, the keyboard module 106 may charge the display module 104. For example, when the keyboard module 106 is connected to the display module 104, the keyboard module 106 may use its battery 240 to charge the battery 232 of the display module 104.

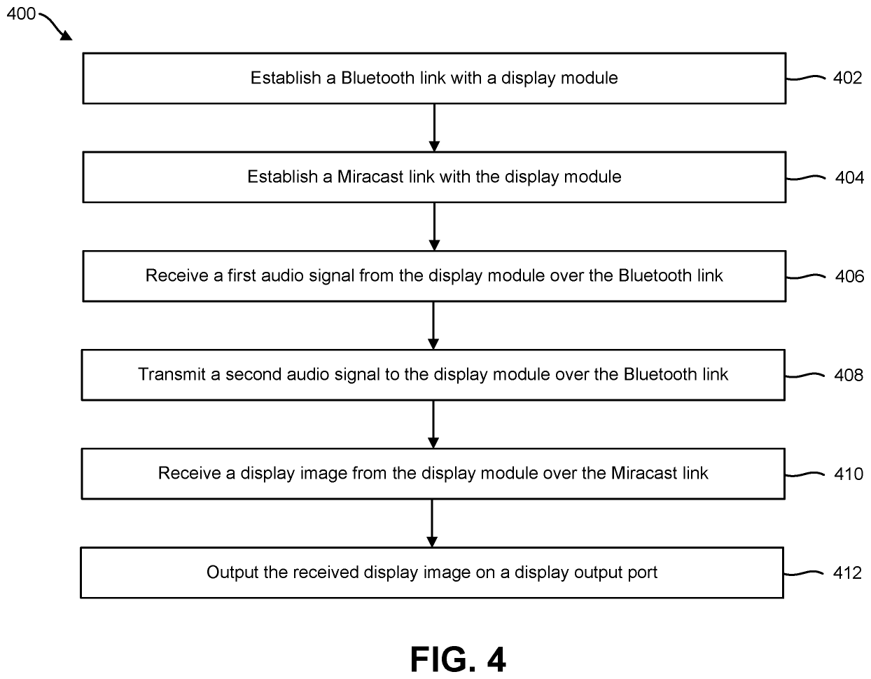

FIG. 4 is a flow diagram illustrating another example of a method 400 by a keyboard module 106. The keyboard module 106 may be separable and wirelessly communicable with a display module 104.

The keyboard module 106 may establish 402 a Bluetooth link with a display module 104. For example, a wireless transceiver 116 of the keyboard module 106 may establish a Bluetooth link with a wireless transceiver 108 of the display module 104.

The keyboard module 106 may establish 404 a Miracast link with the display module 104. For example, a wireless display receiver 118 of the keyboard module 106 may establish a Miracast link with a wireless display transmitter 110 of the display module 104.

The keyboard module 106 may receive 406 a first audio signal 122 from the display module 104 over the Bluetooth link. For example, the display module 104 may use the wireless transceiver 108 to send the first audio signal 122 to the wireless transceiver 116 of the keyboard module 106. In some examples, the keyboard module 106 may output the first audio signal 122 to a speaker 114.

The keyboard module 106 may transmit 408 a second audio signal 126 to the display module 104 over the Bluetooth link. For example, the keyboard module 106 may capture the second audio signal 126 using a microphone 112. The keyboard module 106 may then use its wireless transceiver 116 to send the second audio signal 126 to the wireless transceiver 108 of the display module 104.

The keyboard module 106 may receive 410 a display image 124 from the display module 104 over the Miracast link. For example, the display module 104 may use its wireless display transmitter 110 to send the display image 124 to the wireless display receiver 118 of the keyboard module 106 over the Miracast link.

The keyboard module 106 may output 412 the received display image 124 on a display output port 120. For example, an external display 244 may interface with the display output port 120. The keyboard module 106 may output 412 the display image 124 to the external display 244 using the display output port 120.

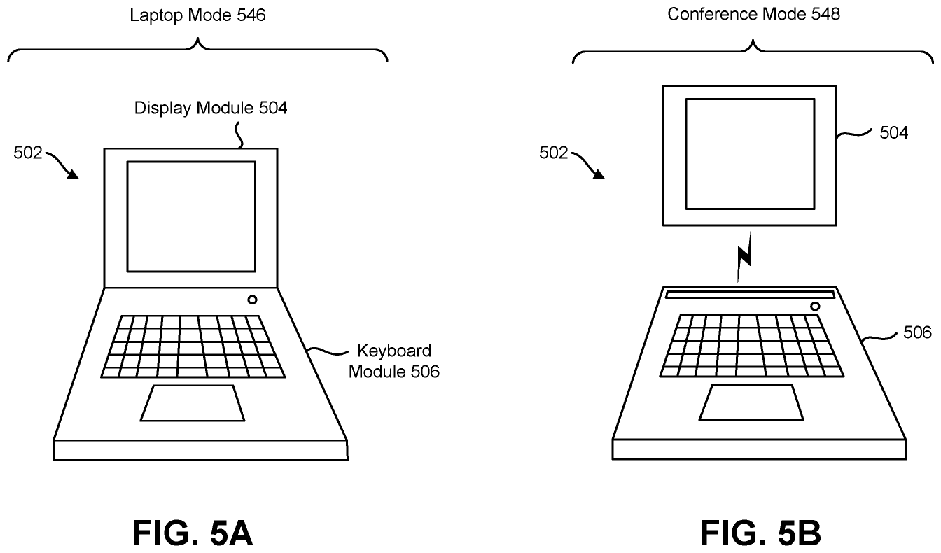

FIGS. 5A and 5B illustrate examples of a computing device 502 in a laptop mode 546 and a conference mode 548. The computing device 502 of FIG. 5 may be implemented in accordance with the computing device 102 of FIG. 1.

In FIG. 5A, the computing device 502 is in a laptop mode 546. In the laptop mode 546, the display module 504 and the keyboard module 506 are physically connected.

In FIG. 5B, the computing device 502 is in conference mode 548. In conference mode 548, the display module 504 and the keyboard module 506 are physically separated and communicate using wireless communication (e.g., Bluetooth, Wi-Fi, Miracast, etc.).

The keyboard module 506 may include its own battery, speaker and microphone to capture and output audio signals. The keyboard module 506 may also output a display image from the keyboard module 506 using a display output port.

It should be noted that the keyboard module 506 may be placed in a location that facilitates capturing and outputting the audio signals. For example, the keyboard module 506 may be placed in the center of a conference room.

While in conference mode 548, the display module 504 may be in a different physical location than the keyboard module 506. For example, a presenter may hold the display module 504 on one side of the conference room while the keyboard module 506 is located on another side of the conference room. This provides flexibility to optimize audio capture of a person speaking and audio output for listeners. Furthermore, when in conference mode 548, the keyboard module 506 may be placed in a convenient location to output the display image of the display module 504 to an external display for the benefit of other people in the conference room.

1. A keyboard module for a computing device that is separable and wirelessly communicable with a display module, the keyboard module comprising:
a wireless transceiver to receive a first audio signal from the display module and to transmit a second audio signal to the display module, the first audio signal to be output by a speaker on the keyboard module, and the second audio signal to be captured by a microphone on the keyboard module;
a wireless display receiver to receive a display image from the display module; and
a display output port to output the received display image for an external display.

2. The keyboard module of claim 1, further comprising a battery to power the keyboard module.

3. The keyboard module of claim 2, wherein the battery further charges the display module when the keyboard module is connected to the display module.

4. The keyboard module of claim 1, wherein the display output port comprises a Universal Serial Bus (USB) interface, DisplayPort interface, High-Definition Multimedia Interface (HDMI) or Video Graphics Array (VGA) interface.

5. The keyboard module of claim 1, wherein the wireless transceiver further wirelessly communicates keyboard input to the display module.

6. A computing device, comprising:
a display module, comprising:
a wireless transceiver to transmit a first audio signal, and
a wireless display transmitter to transmit a display image; and
a keyboard module that is separable and wirelessly communicable with the display module, the keyboard module comprising:
a microphone,
a speaker,
a wireless transceiver to receive the first audio signal from the display module and to transmit a second audio signal to the display module, the first audio signal to be output by the speaker, and the second audio signal to be captured by the microphone,
a wireless display receiver to receive the display image from the wireless display transmitter of the display module, and
a display output port to output the received display image for an external display.

7. The computing device of claim 6, wherein the computing device comprises a laptop.

8. The computing device of claim 6, wherein the wireless display transmitter and the wireless display receiver communicate the display image using Miracast.

9. The computing device of claim 6, wherein the wireless transceiver of the keyboard module and the wireless transceiver of the display module communicate using Bluetooth.

10. The computing device of claim 6, wherein the first audio signal comprises an audio stream received at the display module.

11. The computing device of claim 6, wherein the display image comprises a mirror of a screen of the display module.

12. A method by a keyboard module, comprising:
receiving, at a wireless transceiver, a first audio signal from a display module, the first audio signal to be output by a speaker on the keyboard module;
transmitting, by the wireless transceiver, a second audio signal to the display module, the second audio signal being captured by a microphone on the keyboard module;
receiving, at a wireless display receiver, a display image from the display module; and
outputting, at a display output port, the received display image for an external display.

13. The method of claim 12, further comprising separating the keyboard module from the display module.

14. The method of claim 12, further comprising charging the display module when the keyboard module is connected to the display module.

15. The method of claim 12, further comprising mirroring a screen of the display module to the external display using the display output port.
